(19) United States
(12) Patent Application Publication
(10) Pub. No.: US 2022/0165244 A1
(43) Pub. Date: May 26, 2022

(54) SOUND-ABSORBING MATERIAL

(71) Applicant: Showa Denko Materials Co., Ltd., Chiyoda-ku, Tokyo (JP)

(72) Inventors: Satoshi TAKAYASU, Chiyoda-ku, Tokyo (JP); Ai YOKOKURA, Chiyoda-ku, Tokyo (JP); Tomohiko KOTAKE, Chiyoda-ku, Tokyo (JP)

(21) Appl. No.: 17/602,276

(22) PCT Filed: Apr. 16, 2020
(86) PCT No.: PCT/JP2020/016702

§ 371 Date: Oct. 7, 2021

(30) Foreign Application Priority Data
Apr. 18, 2019 (JP) PCT/JP2019/016685

(51) Int. Cl. G10K 11/168; B32B 3/26; B32B 7/12; B32B 27/06; B32B 27/12

(52) U.S. Cl. CPC G10K 11/168; B32B 3/266; B32B 7/12; B32B 27/065; B32B 2307/732; B32B 2250/03; B32B 2255/205; B32B 2255/10; B32B 2307/102; B32B 27/12

(57) ABSTRACT

A sound-absorbing material includes a resin film; a first substrate layer having communication holes; and a second substrate layer having communication holes, in this order.

### TECHNICAL FIELD

The present invention relates to a sound-absorbing material.

### BACKGROUND ART

Single-layered sound-absorbing structures formed from melt-blown nonwoven fabrics are known (for example, Patent Literature 1).

### CITATION LIST

### Patent Literature

Patent Literature 1: Japanese Unexamined Patent Publication No. 2012-214957

### SUMMARY OF INVENTION

### Technical Problem

In the case of a single-layered sound-absorbing structure formed from a nonwoven fabric, the sound-absorbing characteristics particularly in a low-frequency region are insufficient.

The present invention has been achieved in view of such circumstances as described above, and it is an object of the present invention to provide a sound-absorbing material having excellent sound-absorbing characteristics in a low-frequency region.

### Solution to Problem

The present invention provides a sound-absorbing material comprising a resin film, a first substrate layer having communication holes, and a second substrate layer having communication holes, in this order.

According to an embodiment, each of the first substrate layer and the second substrate layer may be a resin foam or a nonwoven fabric.

According to an embodiment, the thickness of the first substrate layer may be thinner than the thickness of the second substrate layer.

According to an embodiment, the resin film may be formed from a polyolefin, a polyester, or a polyamide.

According to an embodiment, the sound-absorbing material may have a metal vapor deposition layer on at least one surface of the resin film.

According to an embodiment, the sound-absorbing material may further comprise an adhesive layer at least either between the resin film and the first substrate layer or between the first substrate layer and the second substrate layer.

According to an embodiment, the thickness of the sound-absorbing material may be 1 to 100 mm.

According to an embodiment, the sound-absorbing material may have a normal incidence sound absorption coefficient of 0.3 or higher at a certain frequency of 1 kHz or less as measured according to JIS A 1405-1.

### Advantageous Effects of Invention

According to the present invention, a sound-absorbing material having excellent sound-absorbing characteristics in a low-frequency region can be provided.

### BRIEF DESCRIPTION OF DRAWINGS

FIG. 1 is a schematic cross-sectional view of a sound-absorbing material.

FIG. 2 is a diagram showing the normal incidence sound absorption coefficients of Examples.

FIG. 3 is a diagram showing the normal incidence sound absorption coefficients of Examples.

FIG. 4 is a diagram showing the normal incidence sound absorption coefficients of Examples.

FIG. 5 is a diagram showing the normal incidence sound absorption coefficients of Examples.

FIG. 6 is a diagram showing the normal incidence sound absorption coefficients of Examples.

FIG. 7 is a diagram showing the normal incidence sound absorption coefficients of Comparative Examples.

FIG. 8 is a diagram showing the normal incidence sound absorption coefficients of Comparative Examples.

### DESCRIPTION OF EMBODIMENTS

<Sound-Absorbing Material>

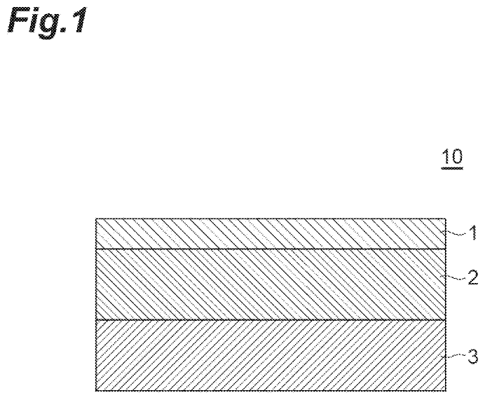

FIG. 1 is a schematic cross-sectional view of a sound-absorbing material. A sound-absorbing material 10 comprises a resin film 1; a first substrate layer 2 having communication holes; and a second substrate layer 3 having communication holes, in this order. Sound (acoustic energy) incident from the resin film side is dissipated as thermal energy when it passes through the sound-absorbing material. As a result, attenuation of sound is observed.

(Substrate Layer)

Examples of the substrate layer having communication holes include a resin foam, a nonwoven fabric, a polymer porous body, and a porous ceramic. Among these, from the viewpoint of having excellent sound-absorbing characteristics in a low-frequency region, the substrate layer may be a resin foam or a nonwoven fabric. The first substrate layer and the second substrate layer may be formed from the same material or may be formed from different materials.

Examples of the material for the resin foam include a polyethylene resin, a polypropylene resin, a polyurethane resin, a polyester resin, an acrylic resin, a polystyrene resin, a melamine resin, a silicone resin, natural rubber, and a synthetic rubber. From the viewpoints of heat resistance, flame retardancy, and the like, the material for the resin foam may be a melamine resin.

Examples of the fiber forming the nonwoven fabric include organic fibers and inorganic fibers. Examples of the organic fibers include fibers of polyolefins such as polyethylene (low-density or high-density), polypropylene, copolymerized polyethylene, and copolymerized polypropylene; fibers of polyesters such as polyethylene terephthalate, polytrimethylene terephthalate, polybutylene terephthalate, polyethylene naphthalate, and polybutylene naphthalate; acrylic fibers, polyamide fibers, nylon fibers, rayon fibers; and natural fibers such as wool. Furthermore, examples of the inorganic fibers include glass fibers, metal fibers, ceramic fibers, and carbon fibers. The fibers forming the nonwoven fabric can comprise one kind or two or more kinds of these.

From the viewpoint of having excellent sound-absorbing characteristics in a low-frequency region, the thickness of the substrate layer can be set to 0.1 to 50 mm and may be 0.5 to 20 mm, may be 2.0 to 20 mm, or may be 2.0 or 10 mm. The first substrate layer and the second substrate layer may have the same thickness or may have different thicknesses. From the viewpoint of having excellent sound-absorbing characteristics in a low-frequency region, the thickness of the first substrate layer (substrate layer on the incident side of sound) may be thinner than the thickness of the second substrate layer.

From the viewpoint of having excellent sound-absorbing characteristics in a low-frequency region, the areal weight of the substrate layer can be set to 10 to 1000 g/m² and may be 30 to 800 g/m², may be 30 to 700 g/m², may be 50 to 500 g/m², or may be 150 to 300 g/m². The first substrate layer and the second substrate layer may have the same areal weight or may have different areal weights.

From the viewpoint of having excellent sound-absorbing characteristics in a low-frequency region, the density of the substrate layer can be set to 0.005 to 1.0 g/cm³ and may be 0.010 to 0.50 g/cm³, may be 0.010 to 0.20 g/cm³, may be 0.020 to 0.20 g/cm³, or may be 0.020 to 0.15 g/cm³. The first substrate layer and the second substrate layer may have the same density or may have different densities.

From the viewpoint of having excellent sound-absorbing characteristics in a low-frequency region, the sound-absorbing material may further comprise another substrate layer having communication holes. That is, the sound-absorbing material may further comprise a third substrate layer having communication holes, a fourth substrate layer having communication holes, and the like in addition to the first substrate layer having communication holes and the second substrate layer having communication holes. Each of the substrate layers may be formed from the same material or may be formed from different materials.

(Resin Film)

Examples of the resin forming the resin film include polyolefin-based resins such as polyethylene (low-density or high-density), polypropylene, copolymerized polyethylene, and copolymerized polypropylene; polyester-based resins such as polyethylene terephthalate, polytrimethylene terephthalate, polybutylene terephthalate, polyethylene naphthalate, and polybutylene naphthalate; fluorine-based resins such as PTFE, FEP, and PFA; polyimide-based resins, polyamide-based resins, aramid-based resins, vinyl chloride-based resins, acrylic resins, polycarbonate-based resins, polyphenylene sulfide-based resins, polyvinyl alcohol-based resins, polystyrene-based resin, polyacrylonitrile-based resins, and ethylene-vinyl acetate-based resins.

From the viewpoint of having excellent sound-absorbing characteristics in a low-frequency region, the thickness of the resin film can be set to 0.5 to 500 μm and may be 5 to 250 μm or may be 10 to 100 μm. The first resin film and the second resin film may have the same thickness or may have different thicknesses. Furthermore, from the viewpoint of having excellent sound-absorbing characteristics in a low-frequency region, the ratio of the thickness of the resin film to the thickness of the substrate layers (thickness of substrate layers/thickness of resin film) can be set to 1 to 20000 and may be 10 to 10000 or may be 100 to 1000.

From the viewpoint of imparting a function of enhancing the sound absorbing effect by adjustment of the film characteristics and a heat-ray reflecting function, the resin film may comprise a metal vapor deposition layer on the surface. That is, the sound-absorbing material may further comprise a metal vapor deposition layer on at least one surface of the first resin film and the second resin film. The metal vapor deposition layer can be formed by physical vapor deposition such as vacuum vapor deposition or chemical vapor deposition of a metal such as aluminum, copper, zinc, a zinc alloy, or silver. The metal vapor deposition layer may be provided on both surfaces of a resin film or may be provided on one surface.

From the viewpoint of enhancing the sound absorbing effect in a low-frequency region and adjusting the sound absorption frequency peak, the resin film may be a perforated film. The perforated film may have holes arranged in a grid pattern or in a diamond pattern. From the viewpoint of having excellent sound-absorbing characteristics in a low-frequency region, these holes may have a circular shape with a diameter of 0.1 to 50.0 mm, may have a circular shape with a diameter of 0.2 to 10.0 mm, or may have a circular shape with a diameter of 0.3 to 5.0 mm. The shape of the holes may be a circular shape, an elliptical shape, a rectangular shape, a polygonal shape, or the like.

From the viewpoint of having excellent sound-absorbing characteristics in a low-frequency region, the resin film may be further provided between the first substrate layer having communication holes and the second substrate layer having communication holes. Furthermore, in a case where the sound-absorbing material further comprises a third substrate layer, a fourth substrate layer, and the like, the resin film may be further provided between those substrate layers. Each of the resin films may be formed from the same material or may be formed from different materials.

(Adhesive Layer)

The sound-absorbing material may further comprise an adhesive layer between the respective above-described layers. For example, the sound-absorbing material may comprise an adhesive layer at least either between the resin film and the first substrate layer or between the first substrate layer and the second substrate layer. Examples of the adhesive layer include, a layer including an adhesive component such as a polyester resin, a vinyl acetate resin, an ethylene-vinyl acetate copolymerized resin, an isobutene-maleic anhydride copolymerized resin, an acrylic copolymerized resin, an acrylic monomer, an acrylic oligomer, a vinyl chloride resin, a urethane resin (including a moisture-curable resin), a silylated urethane resin, an epoxy resin, a modified epoxy resin, a polyolefin resin such as a polyethylene resin, an ionomer resin, a silicone resin, a modified silicone resin, a synthetic rubber such as a styrene-butadiene rubber, a chloroprene rubber, or a nitrile rubber, natural rubber such as isoprene rubber, water glass, or silicate; and a layer formed from a laminate comprising layers containing these adhesive components on both surfaces of a support formed from paper, cloth, a resin tape, a metal tape, or the like. Furthermore, the adhesive layer may also be a product (adhesive sheet) comprising the above-described layer containing an adhesive component or the above-described laminate on both surfaces of a resin film. In this case, as the resin film, the above-described resin films can be used. The respective adhesive layers may be formed from the same material or may be formed from different materials.

The thickness of the adhesive layer is not particularly limited; however, the thickness can be set to 0.01 to 500 μm or may be 1 to 250 μm. The respective adhesive layers may have the same thickness or may have different thicknesses.

From the viewpoints of exhibiting sound-absorbing characteristics, workability of the materials, space saving, and the like, the thickness of the sound-absorbing material can be set to 1 to 100 mm and may be 2 to 50 mm or may be 5 to 30 mm.

The sound-absorbing material can have a normal incidence sound absorption coefficient of 0.3 or higher, or 0.4 or higher, as measured according to JIS A 1405-1 at a certain frequency of 1 kHz or less, specifically at least at any one frequency of 250 Hz, 500 Hz, and 1 kHz. This normal incidence sound absorption coefficient can be set to 0.3 or higher and may also be 0.4 or higher, at 1 kHz. This normal incidence sound absorption coefficient can be set to 0.2 or higher and may be 0.3 or higher, at 750 kHz. This sound absorption coefficient can be set to 0.1 or higher and may be 0.15 or higher, at 500 kHz.

<Method for Producing Sound-Absorbing Material>

The sound-absorbing material can be produced by laminating each of the layers. The sound-absorbing material may be used in a state in which the respective layers are adhered by providing the adhesive layers as described above; however, the sound-absorbing material may also be used without having the respective layers adhered. Furthermore, the adhesive layer may be provided between some layers only. The laminate constituting the sound-absorbing material may be used in a state of being housed in a case.

<Use Application of Sound-Absorbing Material>

The sound-absorbing material has excellent sound-absorbing characteristics in a low-frequency region. Therefore, the sound-absorbing material can be suitably used for use applications such as automobiles, railroad vehicles, aircrafts, ships, buildings such as houses, electronic devices, and precision machines. The low-frequency region as used herein can be set to a region with a frequency of 1 kHz or less and may be a region with a frequency of 800 Hz or less, may be a region with a frequency of 750 Hz or less, or may be a region with a frequency of 500 Hz or less.

### EXAMPLES

Hereinafter, the present invention will be described in more detail by way of Examples; however, the present invention is not intended to be limited to these Examples.

(Preparation of Substrate Layer)

The substrate layers indicated in Table 1 were prepared.

TABLE 1

| Item | Unit | Substrate 1 | Substrate 2 | Substrate 3 | Substrate 4 |
|---|---|---|---|---|---|
| Material | — | Melamine | Polyethylene | Polyolefin | Polyethylene |
| | | resin foam | terephthalate | nonwoven | terephthalate |
| | | | nonwoven fabric | fabric | nonwoven fabric |
| Areal weight | g/m² | 45 | 230 | 250 | 210 |
| Thickness | mm | 5.0 | 7.0 | 3.3 | 2.5 |
| Density | g/cm³ | 0.009 | 0.036 | 0.076 | 0.084 |
| Item | Unit | Substrate 5 | Substrate 6 | Substrate 7 | Substrate 8 |
| Material | — | Polyethylene | Polyolefin | Acrylic | Polyethylene |
| | | terephthalate | nonwoven | nonwoven | terephthalate |
| | | nonwoven fabric | fabric | fabric | nonwoven fabric |
| Areal weight | g/m² | 550 | 220 | 270 | 750 |
| Thickness | mm | 6.0 | 2.2 | 3.0 | 18.0 |
| Density | g/cm³ | 0.092 | 0.100 | 0.090 | 0.042 |

(Preparation of Resin Film)

The following resin films were prepared.

Double-sided aluminum vapor-deposited polyethylene terephthalate film (Al vapor-deposited PET): thickness 12 μm

Polyethylene terephthalate film A (PET-A): thickness 12 μm

Polyethylene terephthalate film B (PET-B): thickness 25 μm

Polyethylene terephthalate film C (PET-C): thickness 50 μm

Polyethylene terephthalate film D (PET-D): thickness 250 μm

Biaxially oriented polypropylene film (OPP): thickness 20 μm

Polyethylene film (PE): thickness 25 μm

(Preparation of Adhesive Layer)

The following adhesive layers were prepared.

Double-sided tape A: 3M Japan Limited, PGD-100 (0.12 mm thick, substrate: nonwoven fabric)

Double-sided tape B: Hitachi Chemical Co., Ltd., HI-BON 25-563 (0.15 mm thick, substrate: Al foil)

Adhesive A: 3M Japan Limited, spray adhesive No. 77

Adhesive B: KLEBCHEMIE M.G. Becker GmbH & Co. KG, polyolefin hot melt resin (966P, 50 g/m² applied)

Adhesive C: KLEBCHEMIE M.G. Becker GmbH & Co. KG, synthetic rubber hot melt resin (939S, 50 g/m² applied)

Adhesive D: KLEBCHEMIE M.G. Becker GmbH & Co. KG, moisture-curable polyurethane hot melt resin (PUR700.5, 50 g/m² applied)

Adhesive sheet A: Product comprising the double-sided tape A on both surfaces of the Al vapor-deposited PET

Adhesive sheet B: Product comprising the layer of the adhesive A on both surfaces of the Al vapor-deposited PET

Adhesive sheet C: Kurabo Industries Ltd., polyolefin hot melt resin sheet (X4300, 0.05 mm thick)

Adhesive sheet D: Kurabo Industries Ltd., polyester sheet hot melt resin sheet (G-5, 0.03 mm thick)

Adhesive sheet E: Kurabo Industries Ltd., polyurethane hot melt resin sheet (S-1700, 0.05 mm thick)

(Production of Sound-Absorbing Material)

Sound-absorbing materials having the configurations shown in Table 2 and Table 3 were produced. For the adhesion of each layer, a double-sided tape, an adhesive, or an adhesive sheet was used. Regarding *1 in the tables, the adhesion between a resin film and a first substrate layer was conducted using the double-sided tape A or the adhesive A, and the adhesion between a first substrate layer and a second substrate layer was conducted using the adhesive sheet A, the adhesive sheet B, or the double-sided tape B.

TABLE 2

| Item | Configuration | Adhesive layer |
|---|---|---|
| Example 1 | Al vapor-deposited PET/substrate 1/substrate 1 | Double-sided tape A |
| Example 2 | Al vapor-deposited PET/substrate 2/substrate 2 | |
| Example 3 | Al vapor-deposited PET/substrate 4/substrate 2 | |
| Example 4 | Al vapor-deposited PET/substrate 4/substrate 5 | |
| Example 5 | Al vapor-deposited PET/substrate 7/substrate 2 | |
| Example 6 | Al vapor-deposited PET/substrate 2/substrate 2 | Adhesive A |
| Example 7 | Al vapor-deposited PET/substrate 3/substrate 2 | |
| Example 8 | Al vapor-deposited PET/substrate 4/substrate 2 | Adhesive B |
| Example 9 | Al vapor-deposited PET/substrate 4/substrate 2 | Adhesive C |
| Example 10 | Al vapor-deposited PET/substrate 4/substrate 2 | Adhesive D |
| Example 11 | PET-A/substrate 4/substrate 2 | Double-sided tape A |
| Example 12 | PET-B/substrate 4/substrate 2 | |
| Example 13 | PET-C/substrate 4/substrate 2 | |
| Example 14 | PET-D/substrate 4/substrate 2 | |
| Example 15 | OPP/substrate 4/substrate 2 | |
| Example 16 | PE/substrate 4/substrate 2 | |
| Example 17 | Al vapor-deposited PET/substrate 3/substrate 2 | Double-sided tape A/adhesive sheet A^{*1} |
| Example 18 | Al vapor-deposited PET/substrate 4/substrate 2 | |
| Example 19 | Al vapor-deposited PET/substrate 2/substrate 2 | Adhesive A/adhesive sheet B^{*1} |
| Example 20 | Al vapor-deposited PET/substrate 4/substrate 2 | |
| Example 21 | Al vapor-deposited PET/substrate 2/substrate 2 | Double-sided tape A/double-sided tape B^{*1} |
| Example 22 | Al vapor-deposited PET/substrate 2/substrate 8 | |
| Example 23 | Al vapor-deposited PET/substrate 4/substrate 2 | Adhesive sheet C |
| Example 24 | Al vapor-deposited PET/substrate 4/substrate 2 | Adhesive sheet D |
| Example 25 | Al vapor-deposited PET/substrate 4/substrate 2 | Adhesive sheet E |

TABLE 3

| Item | Configuration | Adhesive layer |
|---|---|---|
| Comparative Example 1 | Substrate 1 | — |
| Comparative Example 2 | Substrate 1 | |
| | (product having thickness of 10 mm) | |
| Comparative Example 3 | Substrate 2 | |
| Comparative Example 4 | Substrate 5 | |
| Comparative Example 5 | Substrate 6 | |
| Comparative Example 6 | Substrate 8 | |
| Comparative Example 7 | Substrate 1/substrate 1 | Adhesive A |
| Comparative Example 8 | Substrate 2/substrate 2 | |
| Comparative Example 9 | Substrate 3/substrate 2 | |
| Comparative Example 10 | Substrate 4/substrate 2 | |
| Comparative Example 11 | Al vapor-deposited PET/substrate 2 | Double-sided tape A |

(Evaluation of Sound-Absorbing Characteristics of Sound-Absorbing Material)

The normal incidence sound absorption coefficient of each of the produced sound-absorbing materials was measured as follows. Sound was made incident from the layer described on the left-hand side in Table 2. The measurement results are shown in Table 4 and Table 5.

Apparatus name: 4206 type impedance tube (Bruel & Kjaer VTS, Ltd.)

Measurement method: Normal incidence sound absorption coefficient (according to JIS A 1405-1)

Measurement range: 50 to 1600 Hz

TABLE 4

| | Normal incidence sound absorption coefficient | | | |
|---|---|---|---|---|
| Item | 250 Hz | 500 Hz | 750 Hz | 1 kHz |
| Example 1 | 0.04 | 0.17 | 0.31 | 0.59 |
| Example 2 | 0.07 | 0.27 | 0.63 | 0.75 |
| Example 3 | 0.07 | 0.28 | 0.44 | 0.84 |
| Example 4 | 0.05 | 0.27 | 0.55 | 0.45 |
| Example 5 | 0.07 | 0.27 | 0.53 | 0.81 |
| Example 6 | 0.07 | 0.24 | 0.69 | 0.41 |
| Example 7 | 0.06 | 0.15 | 0.45 | 0.49 |
| Example 8 | 0.08 | 0.19 | 0.38 | 0.71 |
| Example 9 | 0.08 | 0.18 | 0.36 | 0.71 |
| Example 10 | 0.02 | 0.16 | 0.37 | 0.56 |
| Example 11 | 0.07 | 0.26 | 0.61 | 0.73 |
| Example 12 | 0.07 | 0.26 | 0.49 | 0.70 |
| Example 13 | 0.07 | 0.29 | 0.50 | 0.63 |
| Example 14 | 0.06 | 0.27 | 0.62 | 0.72 |
| Example 15 | 0.06 | 0.22 | 0.52 | 0.84 |
| Example 16 | 0.08 | 0.30 | 0.50 | 0.82 |
| Example 17 | 0.06 | 0.28 | 0.50 | 0.59 |
| Example 18 | 0.07 | 0.32 | 0.55 | 0.73 |
| Example 19 | 0.08 | 0.38 | 0.72 | 0.68 |
| Example 20 | 0.05 | 0.26 | 0.48 | 0.61 |
| Example 21 | 0.09 | 0.31 | 0.69 | 0.74 |
| Example 22 | 0.16 | 0.69 | 0.86 | 0.54 |
| Example 23 | 0.06 | 0.19 | 0.45 | 0.78 |
| Example 24 | 0.06 | 0.17 | 0.44 | 0.80 |
| Example 25 | 0.08 | 0.18 | 0.39 | 0.76 |

TABLE 5

| | Normal incidence sound absorption coefficient | | | |
|---|---|---|---|---|
| Item | 250 Hz | 500 Hz | 750 Hz | 1 kHz |
| Comparative Example 1 | 0.02 | 0.03 | 0.05 | 0.06 |
| Comparative Example 2 | 0.03 | 0.05 | 0.08 | 0.12 |
| Comparative Example 3 | 0.03 | 0.05 | 0.06 | 0.07 |
| Comparative Example 4 | 0.02 | 0.04 | 0.05 | 0.08 |
| Comparative Example 5 | 0.03 | 0.03 | 0.03 | 0.04 |
| Comparative Example 6 | 0.04 | 0.09 | 0.14 | 0.19 |
| Comparative Example 7 | 0.02 | 0.06 | 0.08 | 0.12 |
| Comparative Example 8 | 0.05 | 0.08 | 0.11 | 0.14 |
| Comparative Example 9 | 0.04 | 0.07 | 0.10 | 0.13 |
| Comparative Example 10 | 0.04 | 0.07 | 0.09 | 0.12 |
| Comparative Example 11 | 0.03 | 0.08 | 0.14 | 0.16 |

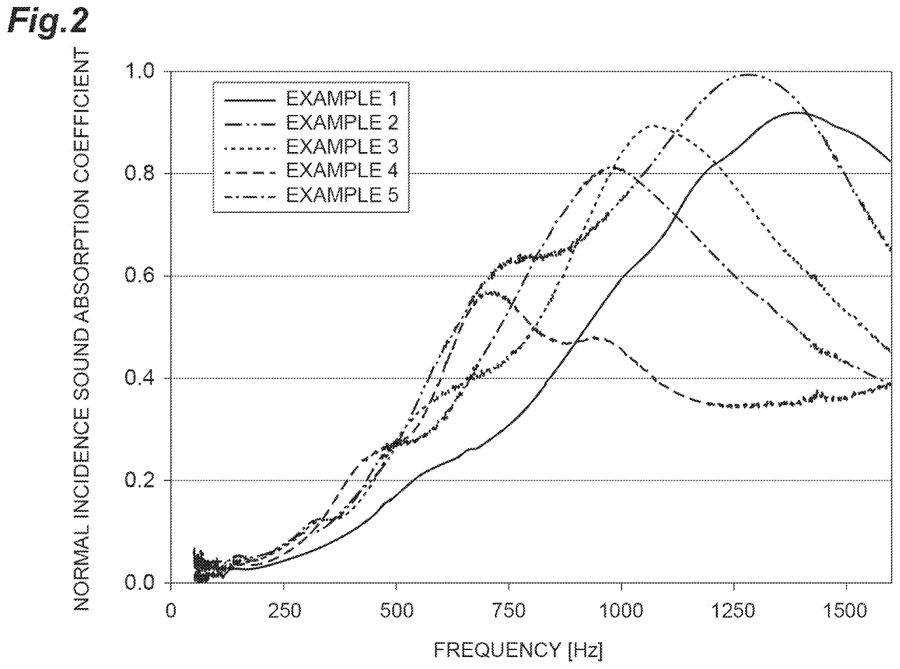

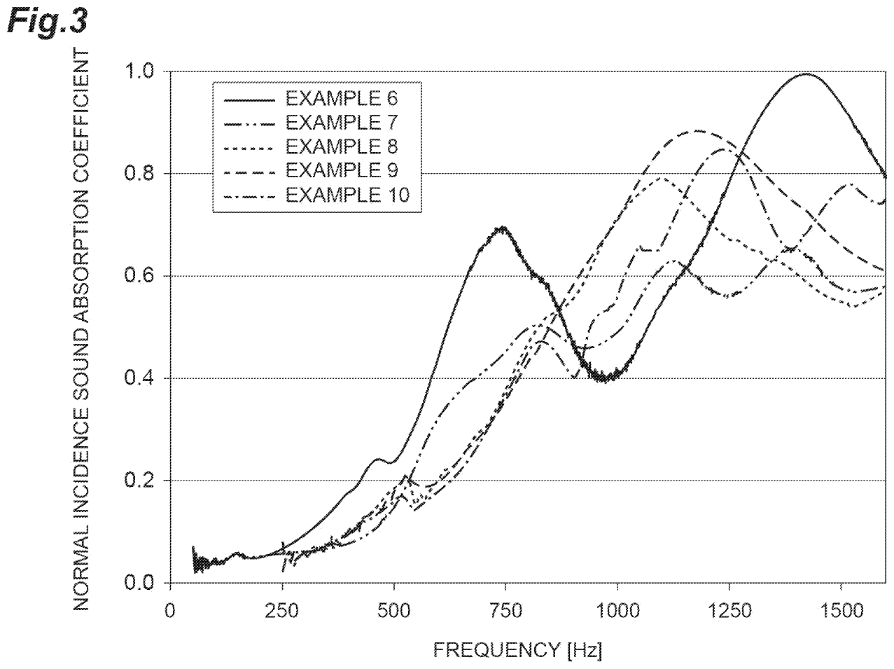

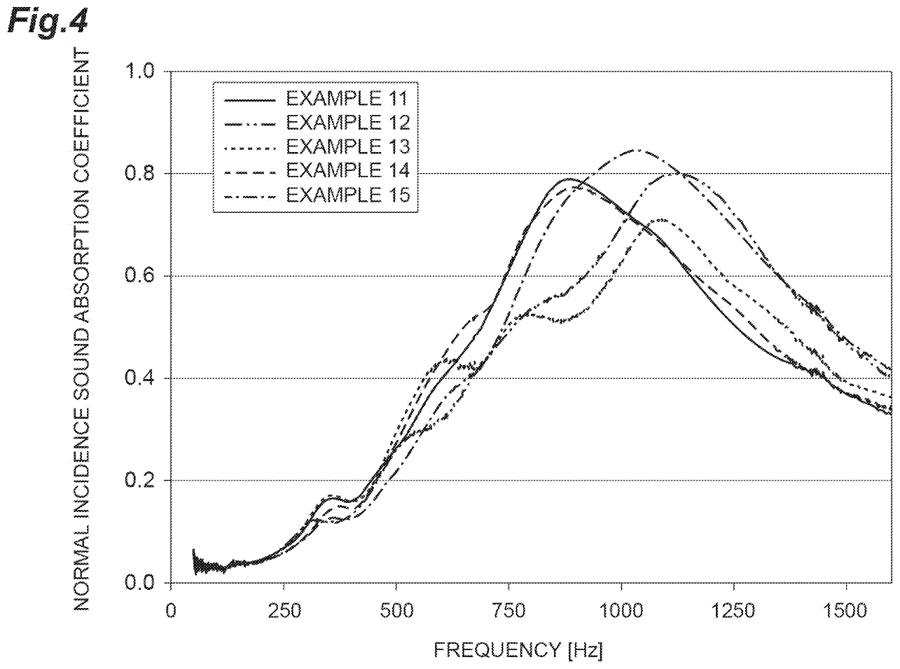

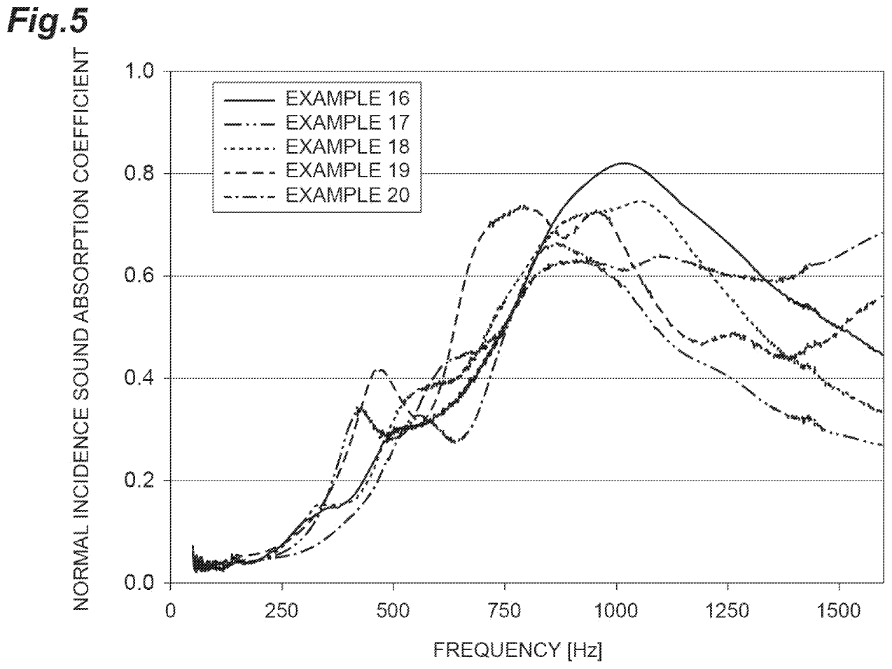

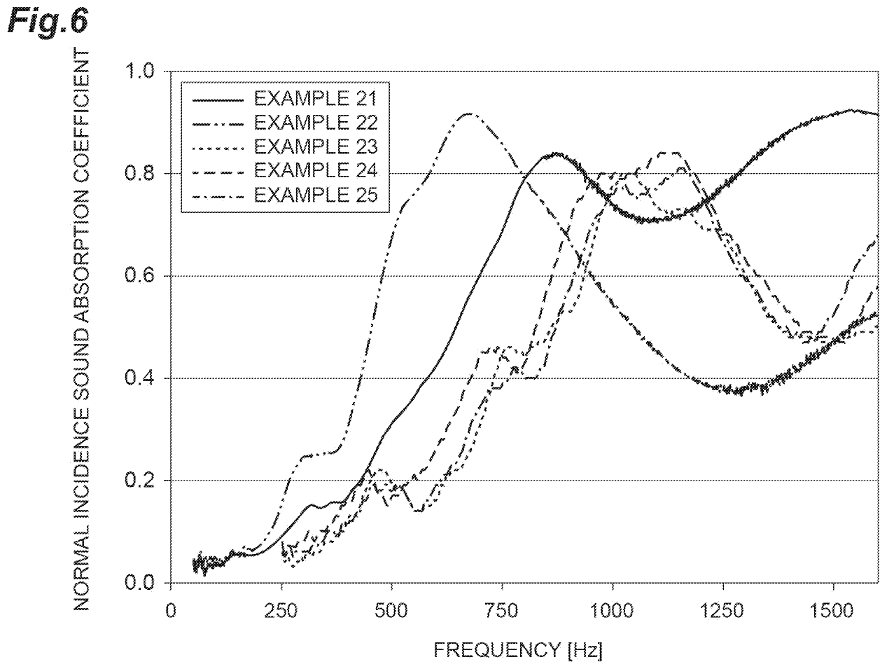

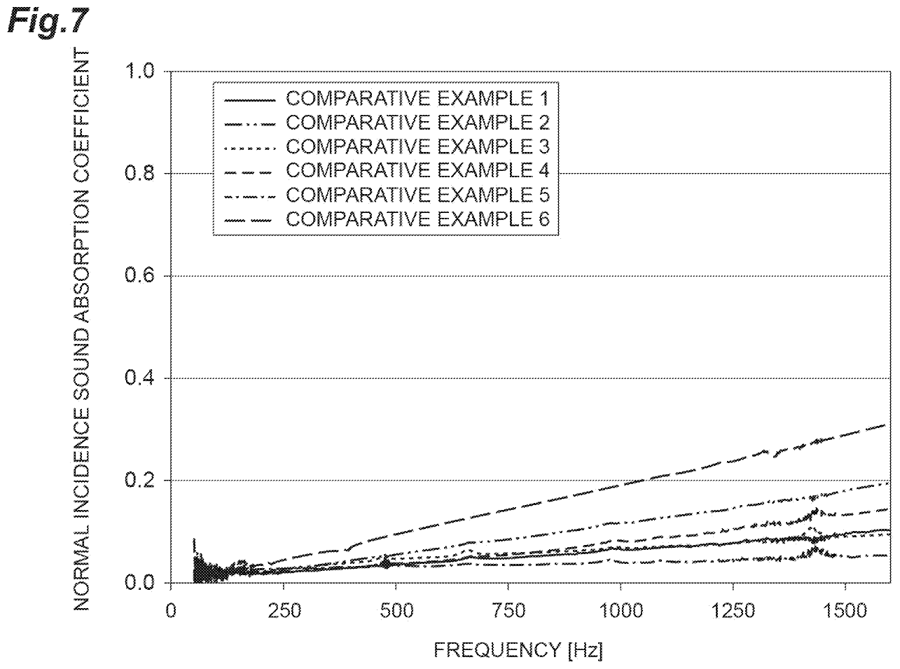

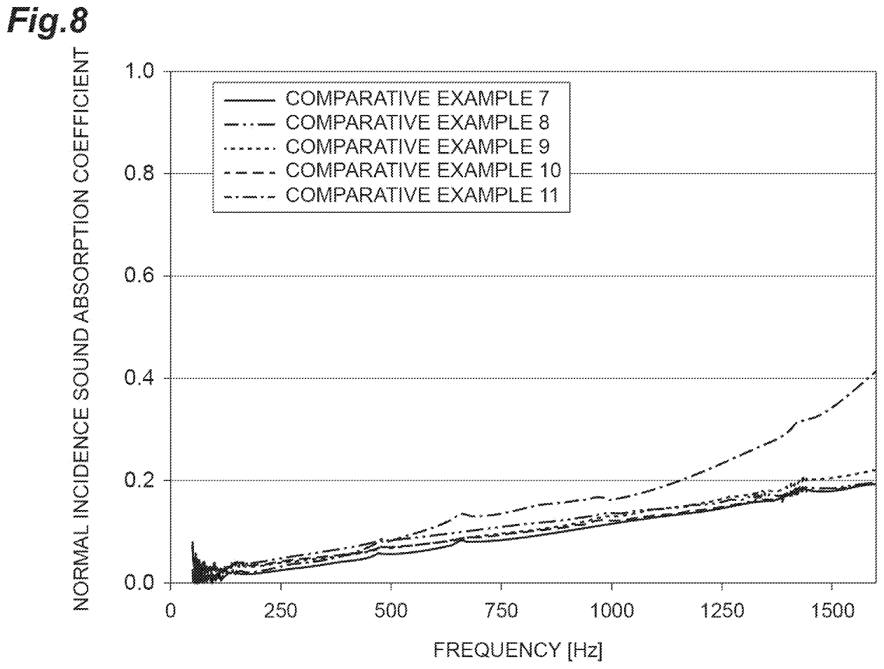

FIGS. 2 to 8 are diagrams showing the respective normal incidence sound absorption coefficients of Examples and Comparative Examples. As shown in the same diagrams, it is understood that the sound-absorbing materials of Examples have excellent sound-absorbing characteristics in a low-frequency region.

### REFERENCE SIGNS LIST

1: resin film, 2: first substrate layer having communication holes, 3: second substrate layer having communication holes, 10: sound-absorbing material.

1. A sound-absorbing material comprising:
a resin film;
a first substrate layer having a first set of communication holes; and
a second substrate layer having a second set of communication holes,
wherein the first substrate layer is located between the resin film and the second substrate layer.

2. The sound-absorbing material according to claim 1, wherein each of the first substrate layer and the second substrate layer comprises a resin foam or a nonwoven fabric.

3. The sound-absorbing material according to claim 1, wherein a thickness of the first substrate layer is thinner than a thickness of the second substrate layer.

4. The sound-absorbing material according to claim 1, wherein the resin film is formed from a polyolefin, a polyester, or a polyamide.

5. The sound-absorbing material according to claim 1, further comprising a metal vapor deposition layer on at least one surface of the resin film.

6. The sound-absorbing material according to claim 1, further comprising at least one adhesive layer located between the resin film and the first substrate layer or between the first substrate layer and the second substrate layer.

7. The sound-absorbing material according to claim 1, wherein a total thickness of the sound-absorbing material is 1 to 100 mm.

8. The sound-absorbing material according to claim 1, wherein the sound-absorbing material has a normal incidence sound absorption coefficient of 0.3 or higher at a frequency of 1 kHz or less as measured according to JIS A 1405-1.

9. The sound-absorbing material according to claim 1, further comprising:
a metal vapor deposition layer formed on the resin film; and
an adhesive layer formed on the first substrate layer.

10. The sound-absorbing material according to claim 9, wherein the metal vapor deposition layer is formed on a first side of the resin film, and wherein a second metal vapor deposition layer is formed on a second side of the resin film, opposite the first side.

11. The sound-absorbing material according to claim 9, wherein the adhesive layer is located between the resin layer and the first substrate layer.

12. The sound-absorbing material according to claim 11, wherein a second adhesive layer is located between the first substrate layer and the second substrate layer.

13. The sound-absorbing material according to claim 9, wherein the adhesive layer is located between the first substrate layer and the second substrate layer.

14. The sound-absorbing material according to claim 1, wherein the resin film comprises a plurality of perforations arranged in a grid pattern or in a diamond pattern.

15. The sound-absorbing material according to claim 1, further comprising a third substrate layer comprising a third set of communication holes.

16. The sound-absorbing material according to claim 1, wherein the first substrate layer comprises a resin foam or a nonwoven fabric.

17. The sound-absorbing material according to claim 1, wherein the second substrate layer comprises a resin foam or a nonwoven fabric.

18. The sound-absorbing material according to claim 1, wherein the first substrate layer comprises porous ceramic or a polymer porous body.

19. The sound-absorbing material according to claim 1, wherein the second substrate layer comprises porous ceramic or a polymer porous body.

20. The sound-absorbing material according to claim 1, wherein the first substrate layer and the second substrate layer comprise a substantially identical material composition.
